(19) United States
(12) Patent Application Publication
(10) Pub. No.: US 2023/0053890 A1
(43) Pub. Date: Feb. 23, 2023

(54) ULTRAHIGH ISOLATION STRIPLINE CIRCUIT

(71) Applicant: International Business Machines Corporation, Armonk, NY (US)

(72) Inventors: Donald Stimson Bethune, San Jose, CA (US); Charles Thomas Rettner, San Jose, CA (US)

(21) Appl. No.: 17/445,257

(22) Filed: Aug. 17, 2021

(51) Int. Cl. H01P 3/08; H01P 1/04

(52) U.S. Cl. CPC H01P 3/081; H01P 1/047

(57) ABSTRACT

A structure that includes a signal trace embedded in a dielectric layer, the signal trace including a first contact pad at one end of the signal trace and a second contact pad at the other end of the signal trace. The dielectric layer has a first ground plane on a first surface and a second ground plane on a second opposing surface. A first conducting ground shield wall on a first side of the signal trace connects the first ground plane to the second ground plane. A second conducting ground shield wall on a second side of the signal trace connects the first ground plane to the second ground plane. The first ground plane, the second ground plane, the first conducting ground shield wall, and the second conducting ground shield wall enclose the signal trace.

### RESEARCH OR DEVELOPMENT

This invention was made with U.S. Government support. The U.S. Government has certain rights in this invention.

### BACKGROUND

The present invention relates generally to the field of high-speed signaling circuits, and more particularly, to a high-speed stripline circuit with very high isolation between closely spaced signaling traces in the circuit.

Stripline circuits are widely used to transmit high speed signals between electronic devices, such as signals between microwave devices operating in the gigahertz frequency range. The traditional stripline circuit is formed of a conductive metal signal line embedded in a dielectric material between two conductive metal ground planes.

As the density of circuitry increases, there is a corresponding need for more dense stripline circuits. However, as the stripline signaling traces are brought closer together, cross-talk between the traces can increase. This may significantly impact performance for applications that are susceptible to such cross-talk between the striplines. In addition, certain applications are extremely sensitive to extraneous signals and fundamentally require high isolation of signal pathways.

To mitigate the effects of crosstalk between adjacent striplines, via fences that connect the ground planes can be fabricated between the signal traces. Via fences are a well-known and relatively inexpensive solution for signal isolation that help to avoid ground plane parallel-plate modes and increase stripline isolation. However, the intermittent structure of a via fence can still allow crosstalk and coupling of adjacent signal traces as the signal frequency increases as a result of electromagnetic radiation from the traces “leaking” through the via fences. The structure of the via fence also introduces an artificial roughness to the stripline structure that can increase return loss and can introduce spurious resonances.

It would be advantageous for a multi-stripline structure to support closely spaced signal traces with a very high isolation, utilizing a “smooth” signal confining structure that minimizes return losses, radiation leakage, and scattering, and avoids undesirable resonances.

### BRIEF SUMMARY

One embodiment of the invention is directed to a structure that includes a signal trace embedded in a dielectric layer, the signal trace including a first contact pad at one end of the signal trace and a second contact pad at the other end of the signal trace. The dielectric layer has a first ground plane on a first surface and a second ground plane on a second opposing surface. A first conducting ground shield wall on a first side of the signal trace connects the first ground plane to the second ground plane. A second conducting ground shield wall on a second side of the signal trace connects the first ground plane to the second ground plane. The first ground plane, the second ground plane, the first conducting ground shield wall, and the second conducting ground shield wall enclose the signal trace.

Another embodiment of the invention is directed to a structure that includes a first signal trace embedded in a dielectric layer. The dielectric layer includes an upper ground plane on a first surface, and a lower ground plane on a second opposing surface. Each of a first pair of vias connect the first signal trace to a separate contact pad within an antipad on one of the first or second surfaces of the dielectric layer. A first continuous conducting ground shield wall, in the dielectric layer, surrounds the first signal trace and the first pair of vias and electrically connects the upper and lower ground planes, such that the first signal trace and the first pair of vias are completely enclosed, except for the antipads, within a continuous conducting ground shield formed of the first ground shield wall and the portions of the upper and lower ground planes within the first ground shield wall.

### BRIEF DESCRIPTION OF THE DRAWINGS

FIG. 1A illustrates a plan view of a stripline structure 100, in accordance with an embodiment of the invention.

FIG. 1B is a cross-section view of the stripline structure of FIG. 1A, taken at line A-A′.

FIGS. 2A and 2B illustrate a set of fabrication process steps for the stripline structure of FIG. 1, in accordance with an embodiment of the present invention.

FIGS. 3A and 3B illustrate a set of fabrication process steps for the stripline structure of FIG. 1, in accordance with an embodiment of the present invention.

FIG. 4 illustrates a set of fabrication process steps for the stripline structure of FIG. 1, in accordance with an embodiment of the present invention.

FIGS. 5A and 5B illustrate a set of fabrication process step for the stripline structure of FIG. 1, in accordance with an embodiment of the present invention.

FIGS. 6A and 6B illustrate a set of fabrication process step for the stripline structure of FIG. 1, in accordance with an embodiment of the present invention.

FIGS. 7A and 7B illustrate a set of fabrication process step for the stripline structure of FIG. 1, in accordance with an embodiment of the present invention.

FIGS. 8A and 8B illustrate a set of fabrication process step for the stripline structure of FIG. 1, in accordance with an embodiment of the present invention.

FIG. 9 illustrates a multi-stripline structure, in accordance with an embodiment of the present invention.

FIGS. 10A and 10B are a flowchart depicting process steps for forming a stripline structure, in accordance with an embodiment of the present invention.

### DETAILED DESCRIPTION

Embodiments of the invention are directed to stripline structures in which each signal line is enclosed by a continuous conducting ground shield. In an exemplary embodiment, the fabrication of the stripline structure is based on circuit board fabrication techniques. For example, a signal trace is formed in one of the metal layers of a double-clad circuit material. A single-clad circuit material is laminated to the signal trace side of the double-clad circuit material to form a stripline structure with the signal trace sandwiched between upper and lower ground planes. A continuous trench is routed on both sides and around the ends of the signal trace. The ground shield walls are formed by lining the trench with a conductive material. The conductive trench liner connects the upper and lower ground planes to form the enclosing ground shield, comprising the ground shield walls and the portions of the upper and lower ground planes within the ground shield walls. Optionally, the trench may be filled to provide structural support. Vias connect the signal trace to contact pads formed within antipads in one of the ground plane layers. In this manner, the stripline is virtually completely enclosed within a continuous smooth ground shield. In a similar fashion, a multi-stripline structure can be fabricated in which the striplines have common upper and lower ground planes, and adjacent striplines are separated by a lined trench. In these embodiments, the continuous enclosing ground shield can reduce cross-talk and other unwanted external electromagnetic radiation at a stripline signal trace by providing a path to ground for the unwanted external electromagnetic radiation. Because the ground shield is continuous, the artificial “roughness” of the traditional via fence is not present, and scattering and return losses can be reduced.

The stripline structure can be integrated, for example, into multilayer circuit boards or as an interposer to connect, for example, dense arrays of microwave devices whose performance will benefit from a high degree of signal isolation. The structure may also be adapted to replace, for example, micro-coax signal bundles to connect, for example, dense arrays of microwave devices whose performance will benefit from a high degree of signal isolation. In this embodiment, a substrate with a degree of flexibility may be used, such as a liquid crystalline polymer (LCP) or other suitable flexible circuit materials.

For the sake of brevity, conventional fabrication techniques related to semiconductor devices, integrated circuits (IC), and circuit materials and laminates may or may not be described in detail herein. Moreover, the various tasks and process steps described herein can be incorporated into a more comprehensive procedure or process having additional steps or functionality not described in detail herein. In particular, various steps in the manufacture of semiconductor devices, semiconductor-based ICs, and multi-layer circuit laminates may be well known and so, in the interest of brevity, many conventional steps may only be mentioned briefly or may be omitted entirely without providing the well-known process details.

For the clarity of the description, and without implying any limitation thereto, illustrative embodiments may be described using simplified diagrams. In an actual fabrication, additional structures that are not shown or described herein, or structures different from those shown and described herein, may be present without departing from the scope of the illustrative embodiments.

Differently patterned portions in the drawings of the example structures, layers, and formations are intended to represent different structures, layers, materials, and formations in the example fabrication, as described herein. A specific shape, location, position, or dimension of a shape depicted herein is not intended to be limiting on the illustrative embodiments unless such a characteristic is expressly described as a feature of an embodiment. The shape, location, position, dimension, or some combination thereof, are chosen only for the clarity of the drawings and the description and may have been exaggerated, minimized, or otherwise changed from actual shape, location, position, or dimension that might be used in actual fabrication to achieve an objective according to the illustrative embodiments.

An embodiment when implemented in an application causes a fabrication process to perform certain steps as described herein. The steps of the fabrication process are depicted in the several figures. Unless such a characteristic is expressly described as a feature of an embodiment, not all steps may be necessary in a particular fabrication process; some fabrication processes may implement the steps in different order, combine certain steps, remove or replace certain steps, or perform some combination of these and other manipulations of steps, without departing the scope of the illustrative embodiments.

The illustrative embodiments are described with respect to certain types of materials, electrical properties, structures, formations, layer orientations, directions, steps, operations, planes, dimensions, numerosity, data processing systems, environments, and components. Unless such a characteristic is expressly described as a feature of an embodiment, any specific descriptions of these and other similar artifacts are not intended to be limiting to the invention; any suitable manifestation of these and other similar artifacts can be selected within the scope of the illustrative embodiments.

The illustrative embodiments are described using specific designs, architectures, layouts, schematics, and tools only as examples and are not limiting to the illustrative embodiments. The illustrative embodiments may be used in conjunction with other comparable or similarly purposed designs, architectures, layouts, schematics, and tools.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed herein.

For purposes of the description, the terms “upper”, “lower”, “right”, “left”, “vertical”, “horizontal”, “top”, “bottom”, “outer”, “inner”, and derivatives thereof relate to the disclosed structures and methods, as oriented in the drawing figures. The terms “overlying”, “atop”, “on top”, “positioned on” or “positioned atop” mean that a first element, such as a first structure, is present on a second element, such as a second structure, and intervening elements, such as an interface structure may be present between the first element and the second element. The term “direct contact”, “directly on top of”, or the like, means that a first element, such as a first structure, and a second element, such as a second structure, are in direct contact without any intermediary conducting, insulating or semiconductor layers at the interface of the two elements.

As used herein, the term “same,” “substantially,” or similar terms, when used for comparing values of a measurement, characteristic, parameter, etc., such as “the same width,” “substantially parallel”, means nominally identical, such as within industry accepted tolerances for the measurement, characteristic, parameter, etc., unless the context indicates a different meaning. As used herein, the terms “about,” “approximately,” or similar terms, when used to modify physical or temporal values, such as length, time, temperature, quantity, electrical characteristics, etc., or when such values are stated without such modifiers, means nominally equal to the specified value in recognition of variations to the values that can occur during typical handling, processing, and measurement procedures. These terms are intended to include the degree of error associated with measurement of the physical or temporal value based upon the equipment available at the time of filing the application. For example, the term “about” or similar can include a range of ±8% or 5%, or 2% of a given value. In one aspect, the term “about” or similar means within 10% of the specified numerical value. In another aspect, the term “about” or similar means within 5% of the specified numerical value. Yet, in another aspect, the term “about” or similar means within 10, 9, 8, 7, 6, 5, 4, 3, 2, or 1% of the specified numerical value. In another aspect, these terms mean within industry accepted tolerances.

For purposes of clarity and ease of explanation, elements shown in the figures are not necessarily drawn to scale. For example, the dimensions of some of the elements may be exaggerated or understated relative to other elements.

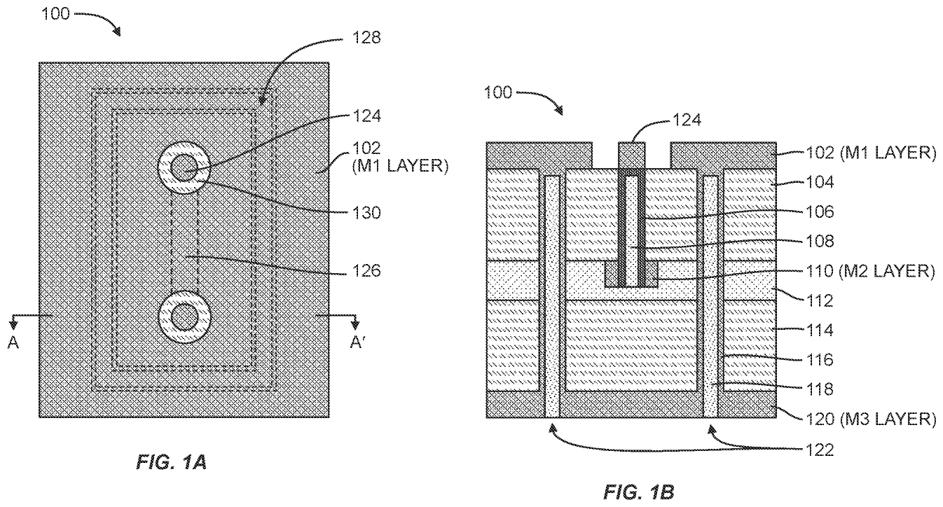

FIG. 1A illustrates a plan view of a stripline structure 100, in accordance with an embodiment of the invention. FIG. 1B illustrates a cross-section view of the stripline structure of FIG. 1A, taken at line A-A′. The stripline structure 100 includes a signal trace 126 with signal trace endpads 110, formed in the M2 layer. The signal trace 126 and signal trace endpads 110 are sandwiched between upper ground plane 102, formed in the M1 layer, and lower ground plane 120, formed in the M3 layer. Vias, formed of a conducting liner 106 and a filler material 108, connect the signal trace end pad 110 to a contact pad 124, formed within antipads 130 in the upper ground layer 102. Ground shield walls are formed by lining continuous trench 122 with a conductive liner 116. The conductive liner 116 extends from lower ground plane 120 to upper ground plane 102, and electrically connects the lower ground plane to the upper ground plane to form the enclosing ground shield, comprising the ground shield walls and the portions of the upper ground plane and the lower ground plane within the ground shield walls. In various embodiments, continuous trench 120 may optionally be filled with a fill material 118 to provide structural support to the stripline structure. In various embodiments, fill material 118 may be a dielectric, a metal, a filled epoxy, etc. As illustrated in FIG. 1A, the lined trench 128 (indicated as buried) surrounds the entire stripline, including the signal trace 126 (indicated as buried) and the vias and their contact pads 124. In this manner, the stripline is virtually completely enclosed within a continuous smooth ground shield. As illustrated, the bottom of the ground shield is formed by M3 layer 120, the sides of the ground shield are formed by lined trench 128 that surrounds the entire stripline, and the top of the ground shield is formed by M1 layer 102.

In the exemplary embodiment of FIGS. 1A and 1B, the stripline structure 100 is formed from a double-clad circuit material comprising dielectric core circuit material 104, the M2 layer, within which signal trace 126 with end pads 110 are formed, and the M1 layer, within which upper ground plane 102 and contact pads 124 are formed. The double-clad circuit material is laminated, using a bondply dielectric material 112, to a single-clad circuit material comprising dielectric core material 114 and the M3 layer, within which lower ground plane 120 is formed.

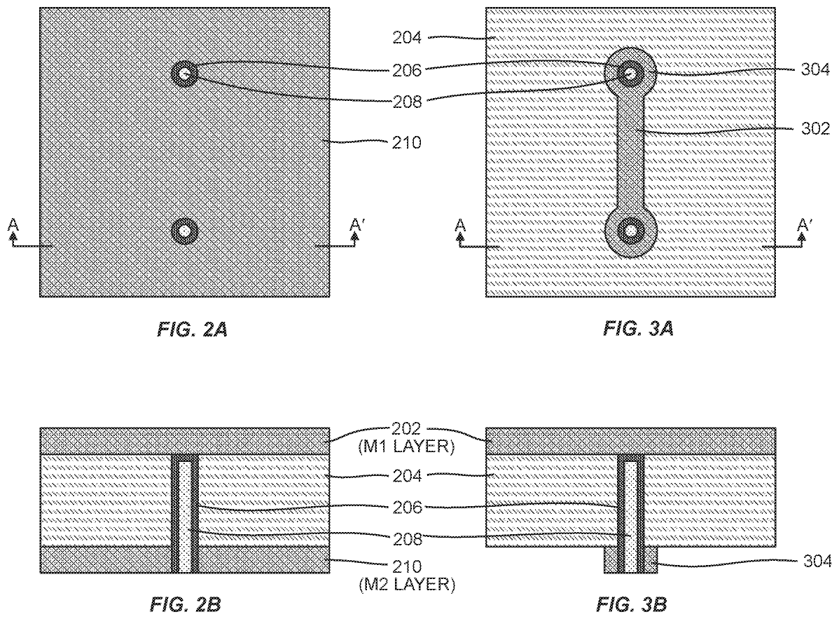

FIGS. 2A and 2B, 3A and 3B, 4, 5A and 5B, 6A and 6B, 7A and 7B, and 8A and 8B represent process steps to fabricate a stripline structure 100, in accordance with an embodiment of the invention.

In FIGS. 2A and 2B, a via is formed between the cladding layers of a double-clad circuit material, formed of M1 layer 202, core dielectric material 204, and M2 layer 210. These vias are at the locations of the signal trace contact pads for the completed stripline structure 100. In an exemplary embodiment, the double-clad circuit material is a laminate formed of an LCP dielectric core with copper cladding. In other embodiments, other flex substrates that satisfy design requirements for suitably low high frequency loss, dielectric constant, and thermal conductivity may be used. By way of a non-exclusive example, the double-clad circuit material may have a thickness of about 25 μm, 50 μm, 100 μm, or 175 μm.

In an embodiment, blind vias are laser drilled through M1 layer 202 and core dielectric material 204, stopping on the bottom side of M2 layer 202. The vias are then lined and plated to form conducting liner 206, and filled with a filler material 208, to electrically connect M1 layer 202 and M2 layer 210. For example, the via side walls may be plasma activated, seeded with graphite, further plated with a Cu seed layer, further plated with Cu to a desired thickness, and filled with a conducting epoxy. By way of a non-exclusive example, the vias may be drilled at a diameter of about 12 mils.

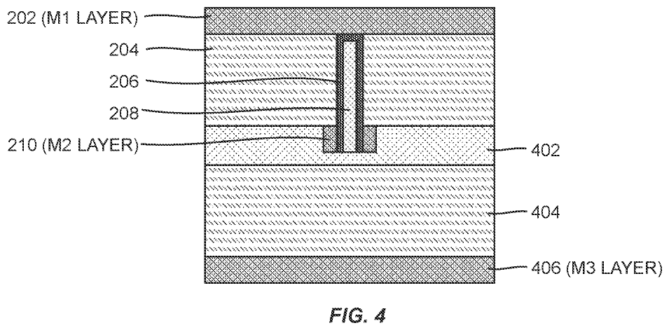

In FIGS. 3A and 3B, a signal trace is formed between the vias formed in the process illustrated in FIGS. 2A and 2B. Signal trace 302 and signal trace endpads 304 around the vias are patterned and etched in M2 layer 210. By way of a non-exclusive example, signal trace 302 may be patterned at a width of about 4 mils, and the signal trace endpads 304 may be patterned at a diameter of about 20 mils.

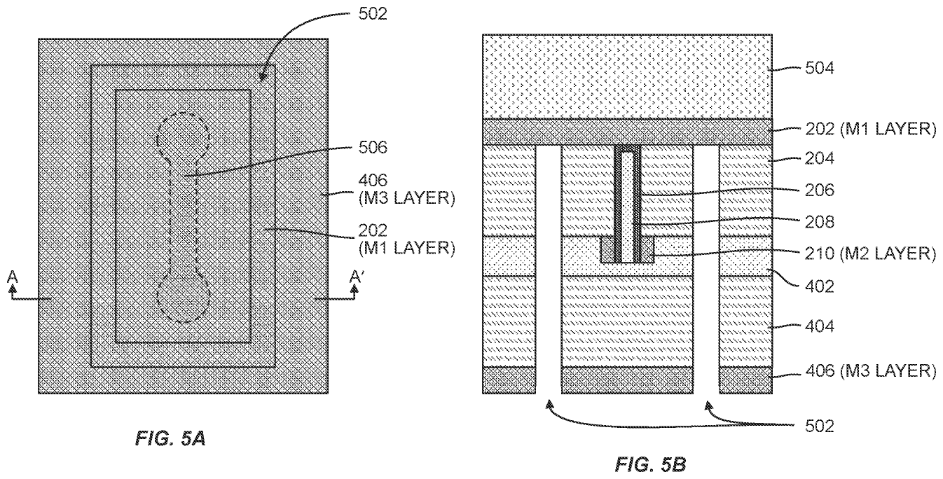

FIG. 4 is a cross-sectional view oriented similar to the view of FIG. 3B. A single-clad circuit material, formed of M3 layer 406 and core dielectric material 404, is laminated, using a bondply dielectric material 402, to the signal trace M2 layer side of the double-clad circuit material. This forms a stripline structure with signal trace 302 sandwiched between M1 layer 202, which acts as an upper ground plane, and M3 layer 406, which acts as a lower ground plane. By way of a non-exclusive example, the thickness of the structure from the outer surface of M1 layer 202 to the outer surface of M3 layer 406 may be about 11 mils (or approximately 280 μm).

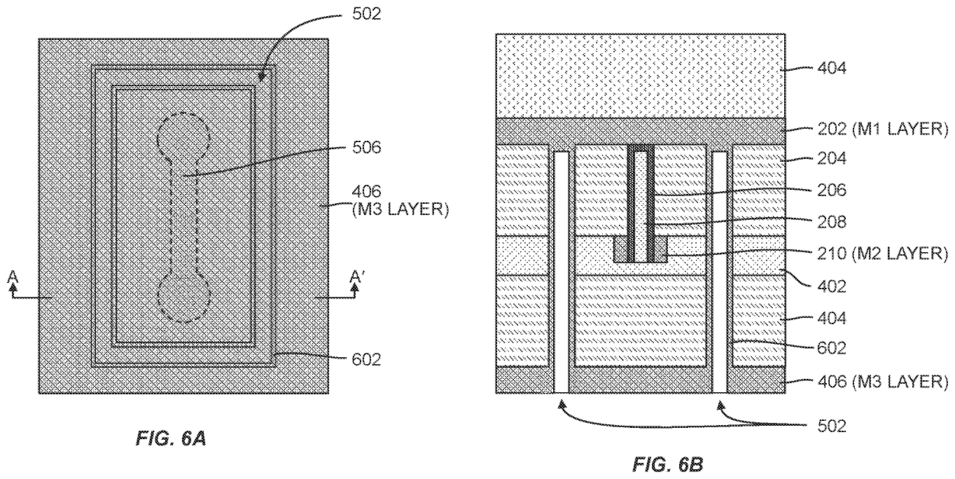

In FIGS. 5A and 5B, a trench 502 is laser routed through M3 layer 406, core dielectric material 404, bondply dielectric material 402, and core dielectric material 204 to land on M1 layer 202. Trench 502 is routed to completely surround signal trace 506 and its endpads (indicated as buried in FIG. 5A). As part of the fabrication process a backing substrate 504 may be temporarily bonded to M1 layer 202.

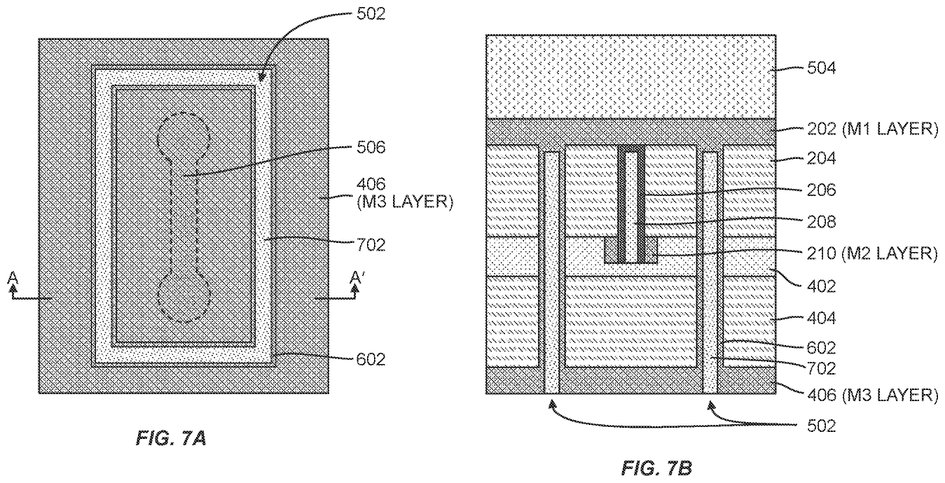

In FIGS. 6A and 6B, trench 502 is lined with a conductive liner 602. As mentioned above, lined trench 502 forms the walls of the ground shield that encloses the stripline signal trace 506. As in the process illustrated in FIGS. 2A and 2B, the trench side walls may be plasma activated, seeded with graphite, further plated with a Cu seed layer, further plated with Cu to a desired thickness.

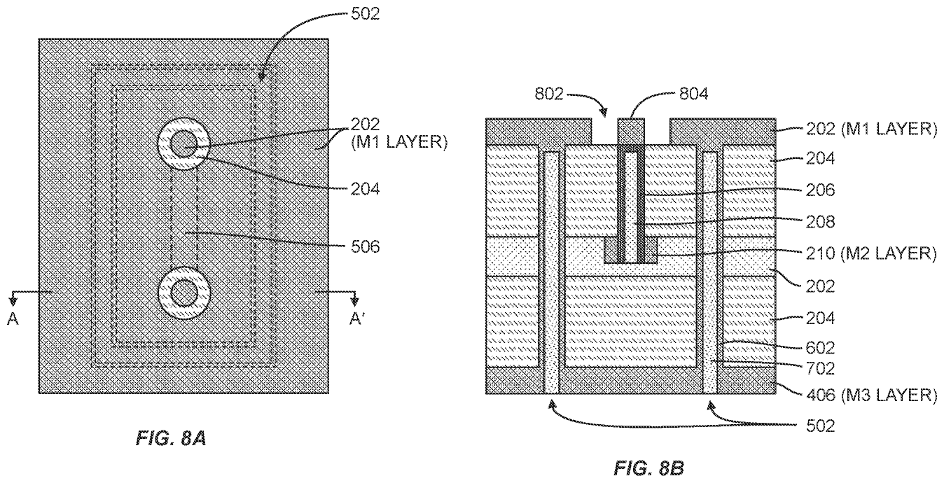

In FIGS. 7A and 7B, lined trenches 502 may optionally be filled, for example, with an epoxy or an elastomer 702 to give the stripline structure flexible mechanical strength.

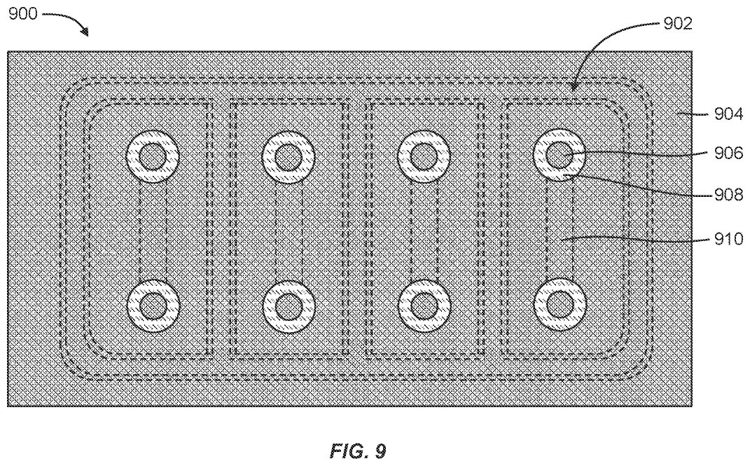

In FIGS. 8A and 8B, the backing substrate 504 is released, and antipads 802 are patterned and etched in the M1 layer 202 around the vias to form contact pads 804.

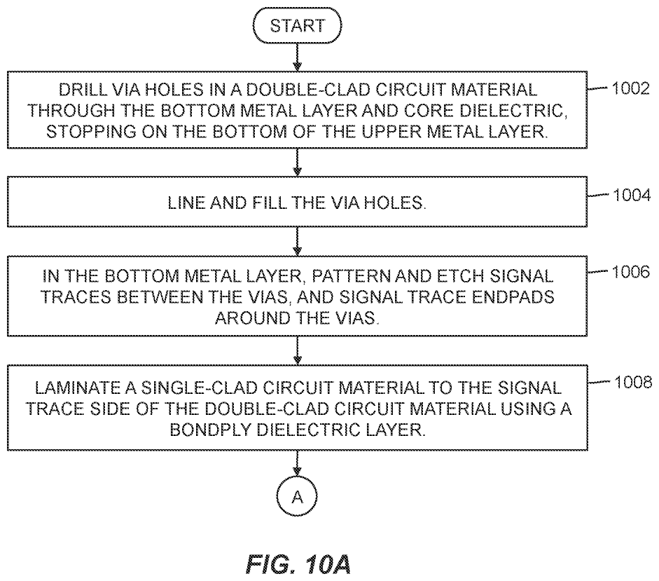

FIG. 9 illustrates a plan view of a multi-stripline structure 900, in accordance with an embodiment of the invention. Stripline structures similar to those illustrated in FIGS. 1A and 1B are fabricated side-by-side, with substantially parallel signal traces 910, and adjacent striplines may share portions of lined trench 902, which form the walls of the ground shields that enclose each individual stripline trace 910.

While exemplary dimensions are given for various aspects of the stripline structures of FIGS. 1A, 1B, and 9, actual dimensions for a particular implementation will be governed by particular design requirements. Generally, at lower lateral densities, the stripline design may be governed by known stripline design considerations, typically based on signal trace width and thickness, the spacing between the ground planes, and the dielectric constant of the dielectric material. As the lateral density increases, the electrical effects of the lined trenches on the signal trace may come into play, and the electrical characteristic of the stripline structures of the various embodiments may begin to resemble those of a coaxial cable. Modeling and design of striplines and coaxial cables is known, and typically, a final design will be based on actual measured performance of prototypes.

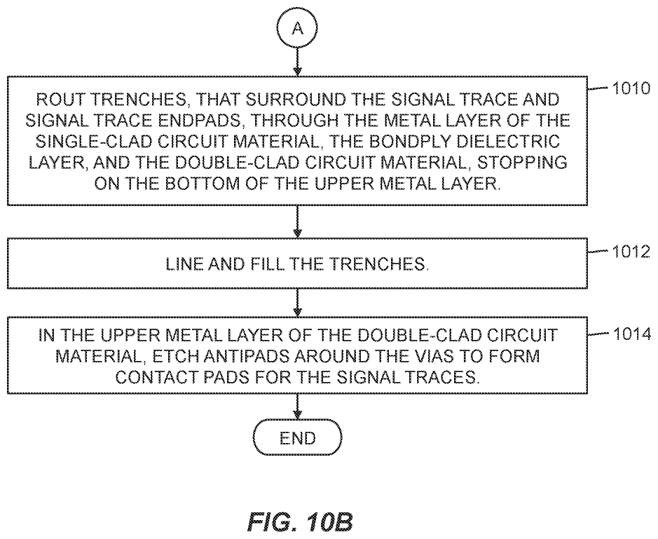

FIGS. 10A and 10B are a flowchart depicting process steps for forming a stripline structure 100, in accordance with an embodiment of the present invention. Via holes are drilled in a double-clad circuit material through the bottom M2 metal layer 210 and core dielectric material 204, stopping on the bottom of the upper M1 metal layer 202. (Step 1002.) The via holes are then lined (206) and filled (808). (Step 1004.) In the bottom M2 metal layer 210, a signal trace 302 and signal trace endpads 304 are patterned and etched. (Step 1006.) A single-clad circuit material, formed of M3 metal layer 406 and core dielectric material 404, is laminated to the signal trace side of the double-clad circuit material using a bondply dielectric layer 402. (Step 1008.) Trench 502 is routed through the M3 metal layer 406, the core dielectric material 404, the bondply dielectric material 402, and the core dielectric material 204, stopping on the bottom of M1 metal layer 202, so as to surround the signal trace 302 and signal trace endpads 304. (Step 1010.) The trench is lined (602) and optionally filled (702). (Step 1012.) Antipads 802 are formed in the M1 metal layer 202 to form contact pads 804. (Step 1014.)

While exemplary embodiments have been presented, the invention may be implemented in other embodiments. For example, while an exemplary embodiment uses pre-fabricated single- and double-clad circuit materials, in an alternative embodiment, a fabrication process may include, for example, the plating and deposition of one or more of the metal and/or dielectric layers. In another example, while an exemplary embodiment uses copper for the M1, M2, and M3 metal layers, other conductive metals may be used, such as tin, indium, or silver.

Based on the foregoing, a structure and a method have been disclosed. However, numerous modifications and substitutions can be made without deviating from the scope of the present invention. Therefore, the present invention has been disclosed by way of example and not limitation.

What is claimed is:

1. A structure comprising:
a signal trace embedded in a dielectric layer, wherein the signal trace includes a first contact pad at one end of the signal trace and a second contact pad at the other end of the signal trace;
a first ground plane on a first surface of the dielectric layer;
a second ground plane on a second opposing surface of the dielectric layer;
a first conducting ground shield wall on a first side of the signal trace that connects the first ground plane to the second ground plane;
a second conducting ground shield wall on a second side of the signal trace that connects the first ground plane to the second ground plane,
wherein the first ground plane, the second ground plane, the first conducting ground shield wall, and the second conducting ground shield wall enclose the signal trace.

2. A structure in accordance with claim 1, wherein the first ground shield wall and the second ground shield wall comprise trenches that are lined with a conducting material.

3. A structure in accordance with claim 1, wherein the first ground shield wall and the second ground shield wall comprise trenches that are lined with copper.

4. A structure in accordance with claim 1, wherein the first ground shield wall and the second ground shield wall comprise trenches that are lined with a conducting material and filled with a material that provides structural support.

5. A structure in accordance with claim 1, wherein the first ground shield wall and the second ground shield wall comprise trenches that are lined with a conducting material and filled with a material selected from the group consisting of: filled epoxy, and an elastomer.

6. A structure in accordance with claim 1, wherein the signal trace, the first ground plane, and the second ground plane are comprised of copper.

7. A structure in accordance with claim 1, wherein the signal trace, the first ground plane, and the second ground plane are formed of a material selected from the group consisting of: indium, tin, and silver.

8. A structure in accordance with claim 1, further comprising:
a second signal trace embedded in the dielectric layer;
a third conducting ground shield wall on a side of the dielectric trace that connects the first ground plane to the second ground plane,
wherein the first ground plane, the second ground plane, the second conducting ground shield wall, and the third conducting ground shield wall enclose the second signal trace.

9. A structure comprising:
a first signal trace embedded in a dielectric layer;
an upper ground plane on a first surface of the dielectric layer;
a lower ground plane on a second opposing surface of the dielectric layer;
a first pair of vias wherein each via connects the first signal trace to a separate contact pad within an antipad on one of the first or second surfaces of the dielectric layer; and
a first continuous conducting ground shield wall, in the dielectric layer, that surrounds the first signal trace and the first pair of vias and electrically connects the upper and lower ground planes, such that the first signal trace and the first pair of vias are completely enclosed, except for the antipads, within a continuous conducting ground shield formed of the first ground shield wall and the portions of the upper and lower ground planes within the first ground shield wall.

10. A structure in accordance with claim 9, wherein the first ground shield wall comprises a trench that is lined with a conducting material.

11. A structure in accordance with claim 9, wherein the first ground shield wall comprises a trench that is lined with copper.

12. A structure in accordance with claim 9, wherein the first ground shield wall comprises a trench that is lined with a conducting material and filled with a material that provides structural support.

13. A structure in accordance with claim 9, wherein the first ground shield wall comprises a trench that is lined with a conducting material and filled with a material selected from the group consisting of: filled epoxy, and an elastomer.

14. A structure in accordance with claim 9, wherein the first signal trace, the upper ground plane, and the lower ground plane are comprised of copper.

15. A structure in accordance with claim 9, wherein the first signal trace, the upper ground plane, and the lower ground plane are formed of a material selected from the group consisting of:
indium, tin, and silver.

16. A structure in accordance with claim 9, further comprising:
a second signal trace embedded in the dielectric layer;
a second pair of vias wherein each via connects the second signal trace to a separate contact pad within an antipad on one of the first or second surfaces of the dielectric layer; and
a second continuous conducting second ground shield wall, in the dielectric layer, that surrounds the second signal trace and the second pair of vias and electrically connects the upper and lower ground planes and the first ground shield wall, such that the signal trace and the pair of vias are completely enclosed, except for the antipads, within a continuous conducting ground shield formed of the ground shield wall and the portions of the upper and lower ground planes within the ground shield wall, and wherein a portion of the first ground shield wall is a portion of the second ground shield wall.

17. A method comprising:
on a double-clad circuit material having a first metal (M1) layer, a second metal (M2) layer, and a dielectric core, patterning and etching a signal trace in the M2 layer that includes a first contact pad at one end of the signal trace and a second contact pad at the other end of the signal trace;
laminating the dielectric face of a single-clad circuit material to the M2 layer, wherein the metal layer of the single-clad circuit material forms a third metal (M3) layer;
routing a first trench between the M1 layer and the M3 layer on a first side of the signal trace;
lining the first trench with a conductive liner such that the M1 and M3 layers are electrically connected;
routing a second trench between the M1 layer and the M3 layer on a second side of the signal trace;
lining the second trench with a conductive liner such that the M1 and M3 layers are electrically connected;
whereby the signal trace is enclosed within a continuous conducting ground shield formed of the first lined trench, the second lined trench, the M1 layer, and the M3 layer.

18. A method in accordance with claim 17, wherein the first and second trenches are lined with copper.

19. A method in accordance with claim 17, further comprising filling the lined first and second trenches with a material that provides structural support.

20. A method in accordance with claim 17, further comprising filling the lined first and second trenches with a material selected from the group consisting of: filled epoxy, and an elastomer.

21. A method in accordance with claim 17, wherein the M1, M2, and M3 layers are comprised of copper.

22. A method in accordance with claim 17, wherein the wherein the M1, M2, and M3 layers are comprised of a material selected from the group consisting of: indium, tin, and silver.

23. A method in accordance with claim 17, further comprising:
patterning and etching a second signal trace in the M2 layer that includes a first contact pad at one end of the second signal trace and a second contact pad at the other end of the second signal trace;
routing a third trench between the M1 layer and the M3 layer on a first side of the second signal trace;
lining the third trench with a conductive liner such that the M1 and M3 layers are electrically connected;
wherein the second signal trace is enclosed within a continuous conducting ground shield formed of the second lined trench, the third lined trench, the M1 layer, and the M3 layer.

24. A method comprising:
forming a first pair of vias that electrically connect a first metal (M1) layer and a second metal (M2) layer of a double-clad circuit material;
patterning and etching a first signal trace in the M2 layer that electrically connects the first pair of vias;
laminating the dielectric face of a single-clad circuit material to the M2 layer, wherein the metal layer of the single-clad circuit material forms a third metal (M3) layer;
routing a continuous first trench between the M1 layer and the M3 layer that surrounds the first signal trace and the first pair of electrically conducting vias;
lining the trench with a conductive liner such that the M1 and M3 layers are electrically connected;
etching a first pair of antipads in the M1 layer to form contact pads for the first pair of electrically conducting vias;
whereby the first signal trace and the first pair of vias are completely enclosed, except for the antipads, within a continuous conducting ground shield formed of the lined trench and the portions of the M1 and M3 layers surrounded by the routed trench.

25. A method in accordance with claim 24, wherein the trench is lined with copper.

26. A method in accordance with claim 24, further comprising filling the lined trench with a material that provides structural support.

27. A method in accordance with claim 24, further comprising filling the lined trench with a material selected from the group consisting of: filled epoxy, and an elastomer.

28. A method in accordance with claim 24, wherein the M1, M2, and M3 layers are comprised of copper.

29. A method in accordance with claim 24, wherein the wherein the M1, M2, and M3 layers are comprised of a material selected from the group consisting of: indium, tin, and silver.

30. A method in accordance with claim 24, further comprising:
forming a second pair of vias that electrically connect the M1 and the M2 layers;
patterning and etching a second signal trace in the M2 layer that electrically connects the second pair of vias;
routing a continuous second trench between the M1 layer and the M3 layer that surrounds the second signal trace and the second pair of electrically conducting vias, wherein a portion of the second trench is a portion of the first trench;
lining the second trench with a conductive liner such that the M1 and M3 layers are electrically connected;
etching a second pair of antipads in the M1 layer to form contact pads for the second pair of electrically conducting vias;
whereby the second signal trace and the second pair of vias are completely enclosed, except for the antipads, within a continuous conducting ground shield formed of the lined second trench and the portions of the M1 and M3 layers surrounded by the routed second trench.
